(19) United States
(12) Patent Application Publication
(10) Pub. No.: US 2026/0093516 A1
(43) Pub. Date: Apr. 2, 2026

(54) ENHANCED LIVE VIRTUAL MACHINE FILE SYSTEM INSTRUMENTATION FOR SECURITY ANALYSIS

(71) Applicant: Palo Alto Networks, Inc., Santa Clara, CA (US)

(72) Inventors: Robert Jung, Albuquerque, NM (US); Michael S. Hughes, Davenport, FL (US); Daniel Raygoza, Seattle, WA (US); Esmid Idrizovic, Trumau (AT); Abhiroop Dabral, Santa Clara, CA (US)

(21) Appl. No.: 18/901,952

(22) Filed: Sep. 30, 2024

(51) Int. Cl. G06F 9/455; G06F 21/56

(52) U.S. Cl. CPC G06F 9/45558; G06F 21/56; G06F 2009/45587

(57) ABSTRACT

Techniques for providing enhanced live virtual machine file system instrumentation for security analysis are disclosed. In some embodiments, a system/process/computer program product for providing enhanced live virtual machine file system instrumentation for security analysis includes receiving a sample for automated dynamic analysis using a computing environment; freezing time in the computing environment in response to detecting an event during execution of the sample in the computing environment and reassemble one or more files; and performing an automated malware analysis using results of the automated dynamic analysis and the one or more reassembled files.

### BACKGROUND OF THE INVENTION

A firewall generally protects networks from unauthorized access while permitting authorized communications to pass through the firewall. A firewall is typically a device or a set of devices, or software executed on a device, such as a computer, that provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1 is a system diagram of an architecture for providing enhanced live virtual machine file system instrumentation for security analysis in accordance with some embodiments.

FIG. 2 is a system diagram of an example file system internals view for providing enhanced live virtual machine file system instrumentation for security analysis in accordance with some embodiments.

FIG. 3 is another system diagram of an example file system internals view for providing enhanced live virtual machine file system instrumentation for security analysis in accordance with some embodiments.

FIG. 4 is a flow diagram for a process for providing enhanced live virtual machine file system instrumentation for security analysis in accordance with some embodiments.

FIG. 5 is another flow diagram for a process for providing enhanced live virtual machine file system instrumentation for security analysis in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls, which can also be implemented using SD-WAN devices).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

### Overview of Techniques for Enhanced Live Virtual Machine File System Instrumentation for Security Analysis

Technical and security challenges with dynamic analysis for providing security exist.

Generally, it is desired during automated dynamic/sandbox analysis to capture files from disk in a timely manner (e.g., prior to the executing process(es) deleting and/or modifying them to evade malware detection) so that such files created/modified can be analyzed pursuant to the malware analysis (e.g., it is also useful to capture various other/supplementary data, such as system logs, etc.).

In order to reduce costs for dynamic analysis for providing security, new and improved techniques are needed to efficiently analyze malware samples (e.g., files and/or other content) at scale. As an example, a commercial security provider typically inspects (e.g., automated malware inspection) billions of malware samples per month, which often involves performing dynamic analysis of hundreds of millions of such malware samples (e.g., sandbox/virtual machine sessions).

Another example technical challenge for efficiently performing such automated inspection of malware samples is obtaining “dropped” files from the dynamic analysis. These are typically files that are written to disk during the course of the dynamic analysis (e.g., sandbox/virtual machine session) as a result of execution of, for example, native executables, script files, and/or macros within documents included in such malware samples.

These files that are written to disk during execution, also referred to herein as secondary artifacts from the dynamic analysis, often contain deobfuscated malicious code or other information that is useful for providing an effective and efficient malware security analysis.

Traditional approaches to address this problem have been to mount the disk once execution is completed during the dynamic analysis and then to fetch the files from disk. However, this traditional approach is computationally expensive. Moreover, this traditional approach is unstable as the disk mounting process can often fail and lead to errors (e.g., and such files may then not be accessible for the security analysis).

As such, new and improved techniques are needed to provide an effective and efficient mechanism to access these files that are written to disk during execution (e.g., secondary artifacts from the dynamic analysis), so that such files can also be examined for providing an enhanced security analysis of the malware samples.

Accordingly, new and improved techniques for enhanced live virtual machine file system instrumentation for security analysis are disclosed.

In some embodiments, a system/process/computer program product for providing enhanced live virtual machine file system instrumentation for security analysis includes receiving a sample for automated dynamic analysis using a computing environment (e.g., an instrumented virtual machine (VM) infrastructure); freezing time in the computing environment in response to detecting an event (e.g., a file system related event and/or an application programming interface (API) related event) during execution of the sample in the computing environment and reassembling one or more files; and performing an automated malware analysis using results of the automated dynamic analysis and the one or more reassembled files.

For example, the computing environment can be implemented using a virtual machine instance, wherein the virtual machine instance provides an enhanced live virtual machine file system instrumentation for security analysis, and wherein a virtual machine infrastructure is instrumented to facilitate extracting one or more files directly from a virtual machine memory and a disk during the automated dynamic analysis. In an example implementation, the virtual machine instance provides an instrumented emulation environment that is executed outside of a guest operating system (OS) virtual machine environment.

In some embodiments, the one or more reassembled files are fully reassembled (e.g., from a memory and/or a disk), wherein the one or more fully reassembled files are automatically analyzed to identify a potential malware binary. Also, the potential malware binary can then be submitted for further dynamic analysis and/or static analysis.

In some embodiments, a system/process/computer program product for providing enhanced live virtual machine file system instrumentation for security analysis further includes stopping execution of a guest operating system in the computing environment and executing one or more read operations to read one or more sector(s) from a disk and/or a memory.

In some embodiments, a system/process/computer program product for providing enhanced live virtual machine file system instrumentation for security analysis further includes stopping execution of a guest operating system in the computing environment and executing one or more read operations to read one or more sector(s) from a disk and/or a memory, wherein the memory includes a file system cache.

In some embodiments, a system/process/computer program product for providing enhanced live virtual machine file system instrumentation for security analysis further includes stopping execution of a guest operating system in the computing environment and executing one or more read operations to read one or more sector(s) from a disk and/or a memory, wherein the memory includes a file system cache; and performing a reconciliation on memory and on disk for the one or more reassembled files.

In an example implementation, the VM infrastructure that includes sandbox analyzers is instrumented to facilitate effective and efficient access to files that are written to disk and/or memory during execution in the sandbox/instrumented VM infrastructure. As will be further described below, this mechanism allows us to efficiently pull files directly from the disk and the VM memory live during the sandbox analysis (e.g., also referred to herein as dynamic analysis).

An example technical and engineering challenge surrounding this solution is that files can exist in different states. For example, when they are not fully flushed to disk, fragments of the file can exist in a combination of places including process memory, kernel file cache, and disk. In order to implement the disclosed techniques for enhanced live virtual machine file system instrumentation for security analysis, the OS and application layer file system implementation were reverse engineered in order to instrument various file system related interactions in a way that can fully reassemble the file during execution, such as will be further described below.

For example, in terms of cost, mounting VM disks millions of times can add up to a significant amount in terms of compute and wall clock time (e.g., actual elapsed time). In contrast, reconstructing a file live during analysis using the disclosed techniques for enhanced live virtual machine file system instrumentation for security analysis is a significantly lower cost in terms of compute and wall clock time as it avoids the expensive operation of mounting an entire file system for a relatively sparse set of files. Another disadvantage of this approach is that files may be altered or missing at the end of the execution in the sandbox/dynamic analysis.

Another approach is also hooking the guest operating system at certain locations when files are open/written/closed. However, this approach tends to be very noisy.

There is also a significant improvement in terms of malware detection accuracy. For example, if a file can be accessed/read the moment it is written or modified, the exact file can be reconstructed (e.g., reassembled) at a given moment in time. In contrast, we can instead wait for the sandbox/dynamic analysis to complete execution/finish (e.g., using a traditional approach that attempts to mount the disk after sandbox/dynamic analysis has completed as discussed above, then we in essence are trusting (i.e., without evidence) that the modified file was not changed or deleted by the malware under analysis). These give rise to significant malware detection loopholes that can lead to false negatives (e.g., failure to properly detect the sample as malware).

Moreover, by applying the disclosed techniques for providing enhanced live virtual machine file system instrumentation for security analysis performance gains can be achieved from capturing only files needed for analysis at runtime/execution time in the sandbox/VM computing environment.

Also, the disclosed techniques for providing enhanced live virtual machine file system instrumentation for security analysis can avoid malware evasions by capturing file data from out-of-guest (e.g., and more precise and complete data recovery than alternative approaches can be achieved as, for example, we can more effectively capture ephemeral data before it is deleted or overwritten and such captured file data can be used for post-analysis or verdict determination), such as further described below These and other embodiments and examples for providing enhanced live virtual machine file system instrumentation for security analysis will be further described below.

### Example System Architectures for Providing Enhanced Live Virtual Machine File System Instrumentation for Security Analysis

As similarly discussed above, a technical challenge exists for accessing secondary artifacts from dynamic analysis for automated security analysis of malware samples. Specifically, existing solutions are inadequate. For example, mounting disks after completion of the automated dynamic/sandbox analysis as such files may be modified or deleted, that mounting process is relatively slow and computationally expensive (e.g., can take on the order of minutes). Also, performing an analysis of a memory dump (e.g., large memory dumps) typically requires using multiple forensics tools and requires significant time and compute resources (e.g., can take on the order of hours) (e.g., and can be limited to partial or small files). Similarly, existing approaches of using intercept file system APIs in the instrumented sandbox/virtual machine (VM) computing environment can be very noisy and are prone to errors (e.g., bug prone and/or missing various edge cases, etc.).

As such, new and improved techniques for providing enhanced live virtual machine file system instrumentation for security analysis will now be further described below.

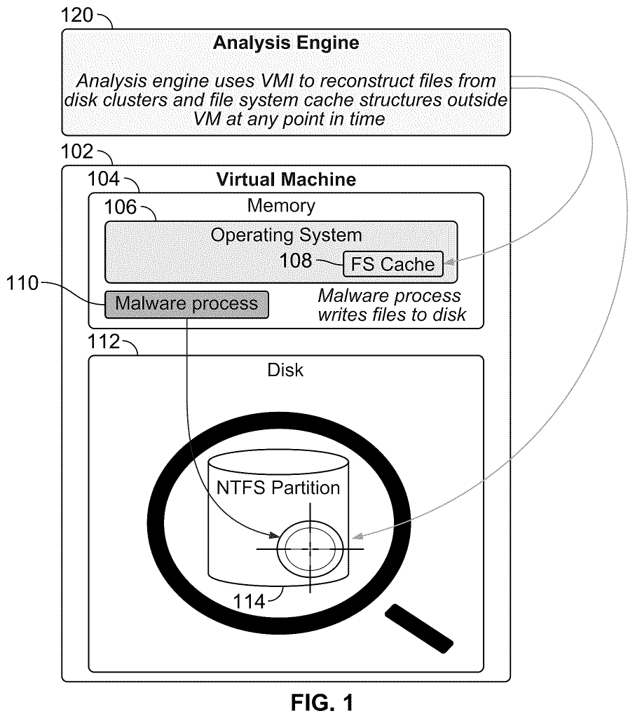

FIG. 1 is a system diagram of an architecture for providing enhanced live virtual machine file system instrumentation for security analysis in accordance with some embodiments.

As an initial processing overview, the disclosed VM-based computing environment shown in FIG. 1, which will be further described below, can be used to perform the following processing workflow. A sample (e.g., received from an enterprise customer's security platform/firewall and/or from another source, at a cloud-based security service that can perform the disclosed automated malware analysis) is received for performing an automated sandbox/dynamic analysis in a virtual environment (e.g., using a custom hypervisor, such as further described below). Specifically, file data for a given file path can then be retrieved (e.g., using an out-of-guest VM OS). Also, additional analysis and parsing of file data as further described below can be performed to facilitate enhanced/improved malware verdict determination, performance analysis, and/or validation, as also further described below with respect to various embodiments.

As similarly described above, there exists several technical challenges for performing file reads during such sandbox/dynamic analysis in a virtual environment (e.g., using a custom hypervisor). First, an in-guest component is generally not invisible. Second, mounting a VM disk and read files after dynamic analysis is complete is not an effective solution as certain files may no longer exist (e.g., the sample writes and deletes files during execution in the sandbox/virtual environment, and as such the file data changes/overwrites during the course of the execution of the sample). Third, capturing memory during the dynamic analysis and using existing tools, such as Volatility, to search for file data is an inadequate solution as there can often be partial files in memory, and moreover, such an approach is computationally inefficient (e.g., generally requires significant computing resources and time).

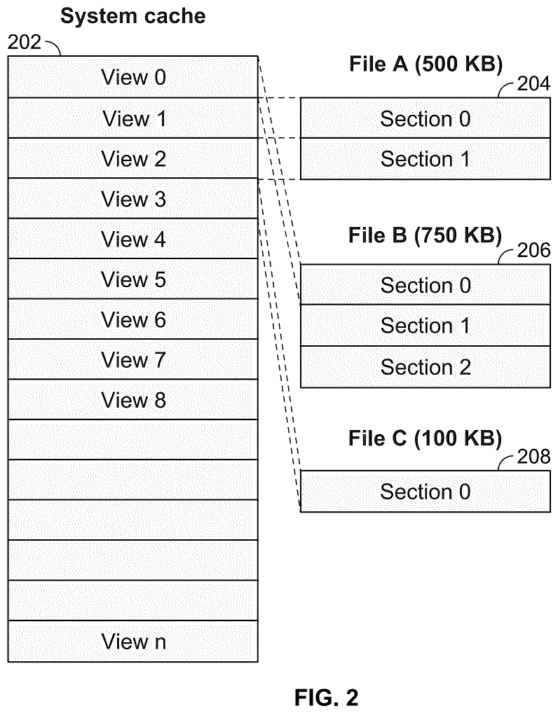

As such, the disclosed techniques for providing enhanced live virtual machine file system instrumentation for security analysis utilize file system parsing in the custom hypervisor as will now be described. The objective is to effectively and efficiently retrieve the current state of file data during any point of execution of the sample during the dynamic analysis in the sandbox/virtual environment as further described below. Specifically, using an out-of-guest OS, the host VM is paused (e.g., but we cannot simply ask the Microsoft Windows OS to provide the file data). The file system (e.g., New Technology File System (NTFS) in this example implementation) is parsed, which can include many data structures as will be further described below. Further, this parsing operation to reconstruct files during the freezing of the dynamic analysis can also be complicated because Windows implements file caching with the Cache Manager, such as further described below with respect to FIG. 2. Moreover, the Windows OS generally performs lazy writes to the disk in the background (e.g., for performance reasons). As such, recent file data changes are most likely only in the cache and not on the disk. Also, some portions of a file may be in cached memory, some may be on the disk. In addition, data structures in memory/cache are slightly different than on the disk.

Referring now to FIG. 1, an example implementation of a solution for providing effective and efficient file system instrumentation with virtual machine introspection (VMI) is provided. As shown, a virtual machine (VM) computing environment 102 is instrumented to facilitate providing enhanced live virtual machine file system instrumentation for security analysis. The VM includes a memory 104, an operating system (OS) 106, and a file system (FS) cache 108. A sample can be executed using the instrumented VM-based computing environment to execute a malware process 110, which in this example, the malware process writes files to a disk 112, which includes a New Technology File System (NTFS) in this Microsoft Windows® OS example (e.g., Windows 7, 10, and/or other Windows OS versions), as shown at 114 in FIG. 1.

Specifically, using Analysis Engine 120, the current state of a file can be reconstructed at any point during the dynamic analysis in this example instrumented VM-based computing environment, such as further described below. More specifically, in this example implementation, an out-of-guest sandbox (e.g., for providing Hypervisor-assisted dynamic malware analysis) is using a custom hypervisor, which can be implemented as will be further described below, to effectively and efficiently obtain file-system data from memory and disk and perform automated and complete reconstruction of any such files generated by malware process 110 during the sandbox/dynamic analysis as further described below.

The disclosed techniques are implemented as described herein in a manner that is not detectable by malware (e.g., malware can attempt to evade detection otherwise), because no modifications are made to the sandbox/virtual machine environment itself.

Also, the disclosed techniques provide an efficient use of Microsoft Windows data structures to locate and retrieve the specified files, such as will be further described below.

In addition, it is noted that Microsoft Windows supports both compressed and encrypted files, which can similarly be located, reconstructed, and retrieved during the dynamic analysis for providing an enhanced security analysis.

Moreover, while this example embodiment is described with respect to a Microsoft Windows and NTFS on the main drive computing environment, the disclosed techniques can be similarly applied to include other file system types (e.g., in this example implementation, FAT32, exFAT), as well as removable drives such as USB.

Further, as would be apparent to one of ordinary skill in the art in view of the disclosed embodiments, the disclosed techniques can be applied to various other OS environments, e.g., Unix, Linux, Apple Mac OS, Apple iOS, Android OS, etc.

FIG. 2 is a system diagram of an example file system internals view for providing enhanced live virtual machine file system instrumentation for security analysis in accordance with some embodiments. For example, in this example implementation, the below described processing can be performed using the VM-based computing environment described above with respect to FIG. 1.

Referring to FIG. 2, as a first stage of processing, the VM is paused to obtain a current Master File Table (MFT). The MFT is the file that keeps track of all files on the disk, including itself. The MFT is generally comprised of cached and disk portions. Specifically, a Master File Table (MFT), reconcile on-disk MFT with in-memory cache (VACBs) from a system cache as shown at 202. More specifically, Microsoft debugging symbols and internally reverse-engineered structures are used. Also, the custom hypervisor API is used to access the MFT from the VM disk and the VM memory (e.g., in this example implementation, the solution is written in Python or another high-level programming language and other APIs/tools can be similarly used to access the MFT and to read data from memory addresses in the VM memory and certain sectors from the VM disk using the disclosed techniques as described herein with respect to various embodiments).

As a second stage of processing, the file data is read to reconstruct File A as shown at 204, File B as shown at 206, and File C as shown at 208 (e.g., based on reassembled respective sections of each of these files as shown in FIG. 2). Specifically, this can be performed by leveraging the reconstructed MFT to find and rebuild data for each specific file, such as shown at 204, 206, and 208 of FIG. 2. As an example of the technical challenges similarly discussed above, some data is resident in the MFT (e.g., in the VM memory) and other data is contained elsewhere on the disk (e.g., the VM disk). More specifically, we overlay any entries in the cache (e.g., VACBs, such as shown in FIG. 2) for that file at specified file offsets. The reconstructed file data may reside on-disk (e.g., the VM disk), in-memory (e.g., the VM memory), or a mix of both. We can then utilize an application programming interface (API) for integration with various dynamic analysis tools (e.g., capturing temporary files, decrypted payloads, etc.).

Also, FIG. 2 illustrates the Cache Manager processing used in the Microsoft Windows and NTFS computing environment. Virtual Address Control Blocks (VACBs) structures represent 256k ‘views’ of files as shown in FIG. 2. The Cache Manager uses the memory manager to determine which pages are in physical memory. Caches are performed on a virtual block basis (e.g., offsets in a file) instead of a logical block basis. Also, multi-level arrays are used, and cache views are shared.

It is also observed based on our experiments that the MFT can change often (e.g., and typically contains some portions on disk and some in memory in VACBs, such as shown in FIG. 2, in which 256k views of files are stored in memory by the Cache Manager and stored in structures called Virtual Address Control Blocks (VACBs)).

In this example implementation, APIs (e.g., custom hypervisor APIs or similar tools with similar APIs) are used to read from disk at certain locations and also from memory at certain locations, and we can then overlay memory changes over disk changes to reconstruct the most up-to-date view of each given file (e.g., the Microsoft Windows OS uses ‘lazy’ writes to changes to disk to attempt to maximize efficiency).

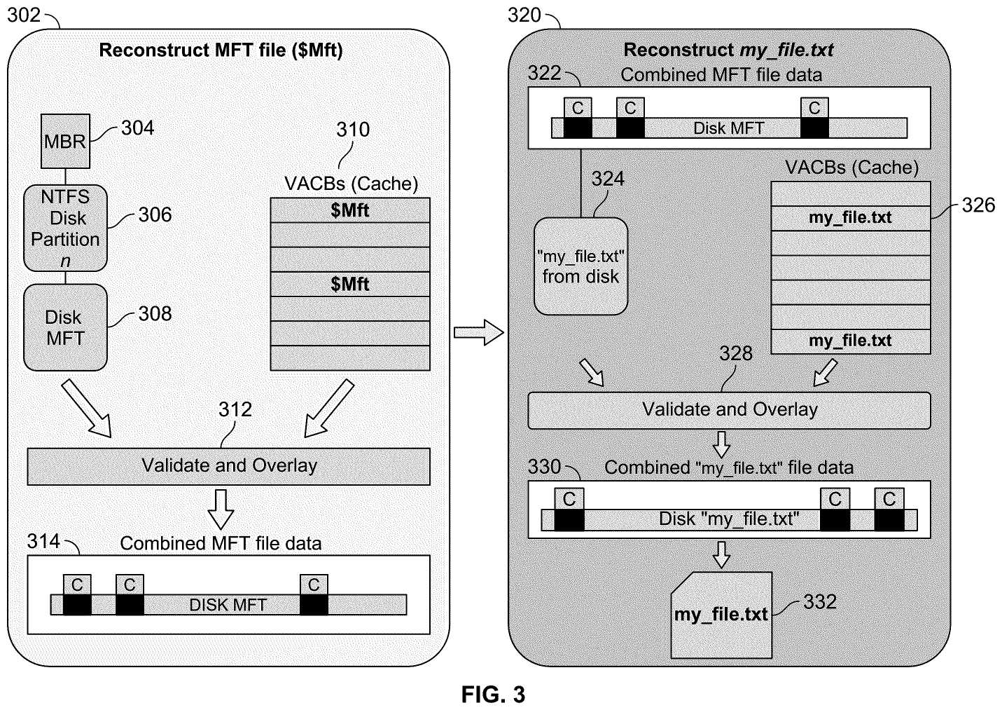

FIG. 3 is another system diagram of an example file system internals view for providing enhanced live virtual machine file system instrumentation for security analysis in accordance with some embodiments. For example, in this example implementation, the below described processing can be performed using the VM-based computing environment described above with respect to FIGS. 1 and 2.

As a first stage of processing in this example implementation as shown at 302 in FIG. 3, the custom hypervisor API is used to read data at file offsets in the VM disk, and the custom hypervisor API is also used to read memory at specific addresses in the VM memory. The MFT can be rebuilt from the disk (e.g., using a Master Boot Record (MBR) file 304, an NTFS Disk Partition 306, and a Disk MFT 308 as shown in FIG. 3), and then we can overlay MFT entries from the cache (e.g., Virtual Address Control Blocks (VACBs) as shown at 310) at specific file offsets to validate and overlay as shown at 312 to generate the combined MFT file data as shown at 314.

As a second stage of processing for reading the file data in this example implementation as shown at 320 in FIG. 3, using the newly constructed, combined MFT as shown at 322, we can find and rebuild data for a specific file from the disk. Some file data is resident in the MFT, and some file data is contained in data that is located elsewhere on the disk. We can then overlay any entries in the cache (e.g., VACBs) for that file at specified file offsets. The final data is a combination of cached data and disk data. Finally, we can provide simplified access through an API call similar to self.guest.disk.read(<file_path>). As such, the file can be reassembled/reconstructed from the VM disk and the VACBs (Cache) as shown at 324 and 326, respectively, and then we can validate and overlay the file data as shown at 328 to generate the combined file data as shown at 330 to generate the complete file as shown at 332.

Additional example processes for the disclosed techniques for providing enhanced live virtual machine file system instrumentation for security analysis will be further described below.

### Example Process Embodiments for Providing Enhanced Live Virtual Machine File System Instrumentation for Security Analysis

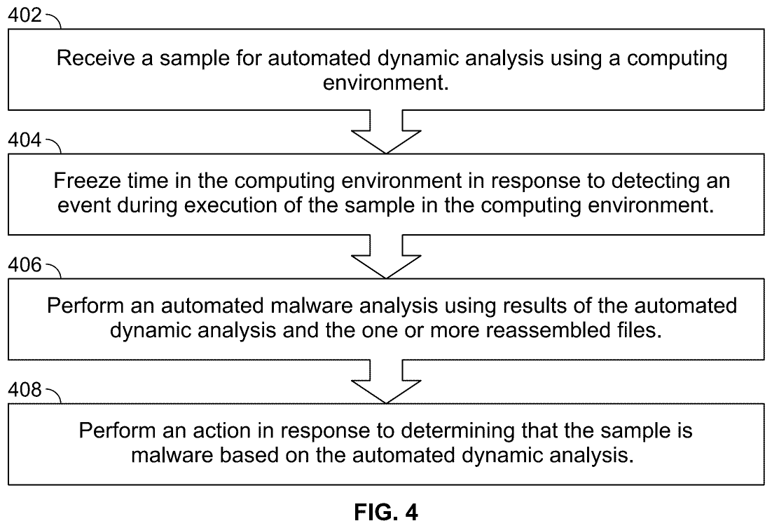

FIG. 4 is a flow diagram for a process for providing enhanced live virtual machine file system instrumentation for security analysis in accordance with some embodiments. In some embodiments, a process as shown in FIG. 4 is performed by the architecture for providing enhanced live virtual machine file system instrumentation for security analysis and techniques as similarly described above including the embodiments described above with respect to FIGS. 1-3.

At 402, a sample is received for automated dynamic analysis using a computing environment. For example, the sample can be received at a cloud-based security service (e.g., from an enterprise customer's security platform/firewall) for performing automated security analysis using dynamic analysis, such as similarly described above.

At 404, freezing time in the computing environment is performed in response to detecting an event during execution of the sample in the computing environment.

At 406, an automated malware analysis using results of the automated dynamic analysis and the one or more reassembled files is performed.

At 408, an action is performed in response to determining that the sample is malware based on the automated dynamic analysis. For example, if the sample is determined to be malware, then an action can be performed, such as to block the connection, drop the file, quarantine the endpoint, associate the source IP address with potential malware, automatically generate a signature (e.g., a hash-based signature for the file), generate an alert, log the malware activity, and/or various other actions or combinations thereof can be performed.

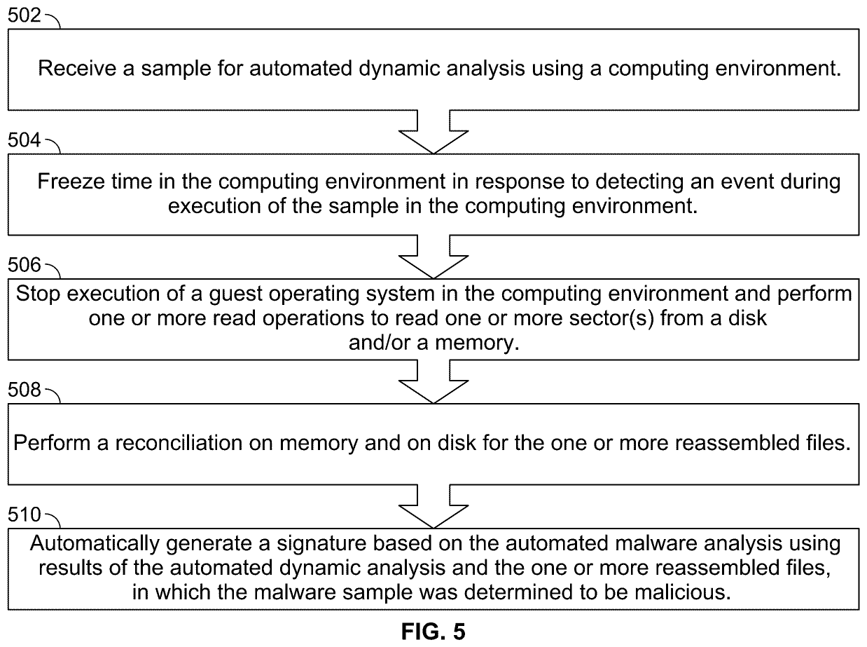

FIG. 5 is another flow diagram for a process for providing enhanced live virtual machine file system instrumentation for security analysis in accordance with some embodiments. In some embodiments, a process as shown in FIG. 5 is performed by the architecture for providing enhanced live virtual machine file system instrumentation for security analysis and techniques as similarly described above including the embodiments described above with respect to FIGS. 1-3.

At 502, a sample is received for automated dynamic analysis using a computing environment. For example, the sample can be received at a cloud-based security service (e.g., from an enterprise customer's security platform/firewall) for performing automated security analysis using dynamic analysis, such as similarly described above.

At 504, freezing time in the computing environment is performed in response to detecting an event during execution of the sample in the computing environment.

At 506, execution of a guest operating system is stopped in the computing environment and one or more read operations to read one or more sector(s) from a disk and/or a memory is performed. For example, the memory can include a file system cache, such as a kernel file cache.

At 508, a reconciliation on memory and on disk for the one or more reassembled files is performed. For example, the fragments of the file can be reassembled from different locations including process memory, kernel file cache, and disk, such as similarly described above.

At 510, a signature is automatically generated based on the automated malware analysis using results of the automated dynamic analysis and the one or more reassembled files, in which the malware sample was determined to be malicious.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a sample for automated dynamic analysis using a computing environment;
freeze time in the computing environment in response to detecting an event during execution of the sample in the computing environment and reassemble one or more files; and
perform an automated malware analysis using results of the automated dynamic analysis and the one or more reassembled files; and
a memory coupled to the processor and configured to provide the processor with instructions.

2. The system recited in claim 1, wherein the computing environment comprises a virtual machine instance.

3. The system recited in claim 1, wherein the computing environment comprises a virtual machine instance, and wherein the virtual machine instance provides an enhanced live virtual machine file system instrumentation for security analysis.

4. The system recited in claim 1, wherein the computing environment comprises a virtual machine instance, wherein the virtual machine instance provides an enhanced live virtual machine file system instrumentation for security analysis, and wherein a virtual machine infrastructure is instrumented to facilitate extracting one or more files directly from a virtual machine memory and a disk during the automated dynamic analysis.

5. The system recited in claim 1, wherein the computing environment comprises a virtual machine instance, and wherein the virtual machine instance provides an instrumented emulation environment that is executed outside of a guest operating system (OS) virtual machine environment.

6. The system recited in claim 1, wherein the one or more reassembled files are fully reassembled.

7. The system recited in claim 1, wherein the one or more reassembled files are fully reassembled, and wherein the one or more fully reassembled files are automatically analyzed to identify a potential malware binary.

8. The system recited in claim 1, wherein the one or more reassembled files are fully reassembled, wherein the one or more fully reassembled files are automatically analyzed to identify a potential malware binary, and wherein the potential malware binary is submitted for further dynamic analysis and/or static analysis.

9. The system recited in claim 1, wherein the one or more reassembled files are fully reassembled from a memory and/or a disk, wherein the memory and the disk are each associated with a virtual machine instance.

10. The system recited in claim 1, wherein the event includes one or more of the following: a file system related event and/or an application programming interface (API) related event.

11. The system recited in claim 1, wherein the processor is further configured to:
stop execution of a guest operating system in the computing environment and execute one or more read operations to read one or more sector(s) from a disk, wherein the disk is associated with a virtual machine instance.

12. The system recited in claim 1, wherein the processor is further configured to:
stop execution of a guest operating system in the computing environment and execute one or more read operations to read one or more sector(s) from a memory and/or a disk, wherein the memory and the disk are each associated with a virtual machine instance, and wherein the memory includes a file system cache.

13. The system recited in claim 1, wherein the processor is further configured to:
stop execution of a guest operating system in the computing environment and execute one or more read operations to read one or more sector(s) from a memory and/or a disk, wherein the memory and the disk are each associated with a virtual machine instance, and wherein the memory includes a file system cache; and
perform a reconciliation on the memory and on the disk for the one or more reassembled files.

14. A method, comprising:
receiving a sample for automated dynamic analysis using a computing environment;
freezing time in the computing environment in response to detecting an event during execution of the sample in the computing environment and reassemble one or more files; and
performing an automated malware analysis using results of the automated dynamic analysis and the one or more reassembled files.

15. The system recited in claim 1, wherein the processor is further configured to:
generate a signature based on the automated malware analysis using results of the automated dynamic analysis and the one or more reassembled files, wherein the sample was determined to be malicious.

16. The method of claim 14, wherein the computing environment comprises a virtual machine instance.

17. The method of claim 14, wherein the computing environment comprises a virtual machine instance, and wherein the virtual machine instance provides an enhanced live virtual machine file system instrumentation for security analysis.

18. The method of claim 14, wherein the computing environment comprises a virtual machine instance, wherein the virtual machine instance provides an enhanced live virtual machine file system instrumentation for security analysis, and wherein a virtual machine infrastructure is instrumented to facilitate extracting one or more files directly from a virtual machine memory and a disk during the automated dynamic analysis.

19. A computer program product, the computer program product being embodied in a tangible computer readable storage medium and comprising computer instructions for:
receiving a sample for automated dynamic analysis using a computing environment;
freezing time in the computing environment in response to detecting an event during execution of the sample in the computing environment and reassemble one or more files; and
performing an automated malware analysis using results of the automated dynamic analysis and the one or more reassembled files.

20. The computer program product recited in claim 19, wherein the computing environment comprises a virtual machine instance.
